(19) United States
(12) Patent Application Publication
(10) Pub. No.: US 2026/0369642 A1
(43) Pub. Date: Nov. 19, 2026

(54) METHOD FOR MANUFACTURING A CATALYST-COATED MEMBRANE

(71) Applicant: JOHNSON MATTHEY HYDROGEN TECHNOLOGIES LIMITED, London (GB)

(72) Inventors: Jake COOLE, Swindon (GB); Jake Benjamin HOWELLS, Swindon (GB); Julie O'SULLIVAN, Swindon (GB); Wayne TURNER, Swindon (GB)

(21) Appl. No.: 19/154,219

(22) PCT Filed: Mar. 28, 2024
(86) PCT No.: PCT/GB2024/050851

§ 371 Date: Aug. 6, 2025

(30) Foreign Application Priority Data
Mar. 31, 2023 (GB) 2304796.2

(51) Int. Cl. H01M 8/1004; C25B 1/04; C25B 9/23; C25B 11/065; C25B 11/081; H01M 4/88; H01M 4/92

(52) U.S. Cl. CPC H01M 8/1004; C25B 1/04; C25B 9/23; C25B 11/065; C25B 11/081; H01M 4/8828; H01M 4/8882; H01M 4/926

(57) ABSTRACT

A method of manufacturing catalyst-coated ion-conducting membrane for use in an electrochemical device such as a fuel cell or electrolyser. The method comprises providing an electrolyte membrane having a first face and a second face, the first face being disposed opposite to the second face. A first catalyst ink is deposited onto the first face of the electrolyte membrane to form a first wet catalyst layer and then dried to form a first catalyst layer on the first surface of the electrolyte membrane. The first catalyst ink comprises a first ion-conducting polymer; a first electrocatalyst; and a first dispersant. Subsequently, a second catalyst ink is deposited onto the second face of the electrolyte membrane to form a second wet catalyst layer and dried to form a second catalyst layer. The second catalyst ink comprises a second ion-conducting polymer; a second electrocatalyst; and a second dispersant.

### FIELD OF THE INVENTION

This invention relates to methods of manufacturing a catalyst-coated membrane for an electrochemical device, such as a fuel cell or an electrolyser. This invention also relates to associated catalyst-coated membranes.

### BACKGROUND OF THE INVENTION

The electrolysis of water to produce high purity hydrogen and oxygen can be carried out in both alkaline and acidic electrolyte systems. Those electrolysers that employ an electrolyte membrane which is a solid proton-conducting polymer membrane, or proton exchange membrane (PEM), are known as proton exchange membrane water electrolysers (PEMWEs). Those electrolysers that utilise a solid anion-conducting polymer membrane, or anion exchange membrane (AEM), are known as anion exchange membrane water electrolysers (AEMWEs).

Electrolyte membranes (also known as ion-conducting membranes), such as PEMs and AEMs, are also used in fuel cells. In a proton exchange membrane fuel cell (PEMFC) the membrane is proton conducting, and protons, produced at the anode, are transported across the membrane to the cathode, where they combine with oxygen to form water.

Catalyst-coated membranes (CCMs) may be employed within electrochemical devices, such as electrolysers and fuel cells. Such CCMs comprise an electrolyte membrane, such as a PEM or AEM, with an anode catalyst layer and/or a cathode catalyst layer applied to a face of the membrane, the anode catalyst layer and cathode catalyst layer being applied to opposite faces of the membrane.

For water electrolyser applications, hydrogen evolution reaction (HER) catalysts are used in such cathode catalyst layers, for example HER catalysts comprising platinum, such as platinum on a carbon support. Oxygen evolution reaction (OER) catalysts are utilised in electrolyser anode catalyst layers. For PEMWE applications, suitable OER catalysts comprise iridium or iridium oxide, or oxides containing both iridium and ruthenium. For AEMWE applications, non-platinum group metal OER catalysts may also be used, such as alloys and oxides of nickel, cobalt, iron, and copper.

For fuel cell applications, oxygen reduction reaction (ORR) catalysts are used in cathode catalyst layers and hydrogen oxidation reaction (HOR) catalysts are utilised in anode catalyst layers. For PEMFC applications, suitable cathode and anode catalyst materials comprise a platinum group metal or an alloy of a platinum group metal with one or more other metals, for example platinum or an alloy of platinum with one or more other metals.

CCMs may be incorporated into a membrane electrode assembly (MEA), which is essentially composed of five layers. The central layer is the electrolyte membrane. On either side of the electrolyte membrane there is an electrocatalyst layer, containing an electrocatalyst designed for the specific electrolytic reaction. Finally, adjacent to each electrocatalyst layer there is a gas diffusion layer or a porous transport layer, depending on the final MEA application and stack configuration. Such layers allow the reactants to reach the electrocatalyst layer and products to leave.

The membrane electrode assembly can be constructed by a number of known methods. A common method involves depositing one or both of the electrocatalyst layers on a decal transfer substrate and transferring the electrocatalyst layers to either side of the ion-conducting membrane. Subsequently, a gas diffusion layer is applied to the electrocatalyst layer. Alternatively, an electrocatalyst layer can be applied to a gas diffusion layer to form a gas diffusion electrode, which is then combined with the ion-conducting membrane. A membrane electrode assembly can be prepared by a combination of these methods e.g., one electrocatalyst layer is applied to the ion-conducting membrane to form a catalyst-coated ion-conducting membrane, and the other electrocatalyst layer is applied as a gas diffusion electrode. The electrocatalyst layers are applied using an electrocatalyst ink which conventionally comprises an electrocatalyst material, an ion-conducting polymer, solvents/dispersants and/or diluents, and any agents desired to be included in the electrocatalyst layer.

The demand for hydrogen-based solutions for the reduction of carbon emissions is expected to continue to grow rapidly in response to net-zero targets. In order to respond to this demand, rapid increases in the volume of production of key components, such as CCMs, are required. There are significant benefits in minimising the use of key raw materials (such as platinum group metal catalysts, for example iridium-based catalyst materials, and ion-conducting polymers), in the reduction of waste, and in the facilitation of recycling.

There remains a need to further enhance and develop methods for the production of catalyst-coated ion-conducting membranes, in particular methods which enable large scale manufacturing, whilst optimising the use and recycling of key raw materials.

### SUMMARY OF THE INVENTION

In a first aspect of the invention, there is provided a method of manufacturing a catalyst-coated membrane, the method comprising
providing an electrolyte membrane having a first face and a second face, the first face being disposed opposite to the second face;
depositing a first catalyst ink onto the first face of the electrolyte membrane to form a first wet catalyst layer; the first catalyst ink comprising a first ion-conducting polymer, a first electrocatalyst, and a first dispersant; and drying the first wet catalyst layer to form a first catalyst layer on the first surface of the electrolyte membrane; and
   depositing a second catalyst ink onto the second face of the electrolyte membrane (opposite to the first catalyst layer) to form a second wet catalyst layer, the second catalyst ink comprising a second ion-conducting polymer, a second electrocatalyst, and a second dispersant; and drying the second wet catalyst layer to form a second catalyst layer;
   wherein the first catalyst layer is subjected to a temperature A before the second catalyst ink is deposited onto the second face of the electrolyte membrane and the temperature A is 130 °C or more; and wherein the second catalyst layer is subjected to a temperature B and the second temperature B is lower than the temperature A.

The method may be described as a direct-to-membrane (DTM) manufacturing method, which is different from the conventional decal method. The DTM method requires the catalyst ink to be applied directly to the electrolyte (ion-conducting) membrane, rather than to a decal transfer substrate or gas diffusion layer.

A DTM method can provide a number of benefits relative to the decal method. For example, fewer steps may be required increasing efficiency. If a hot press is avoided, a higher quality CCM may be obtained. For example, the CCM may have more even (consistent thickness) layers. A hot press employs high temperatures and pressures that can lead to deformation.

While some DTM processes are known, they are not widely adopted since electrolyte membranes can become dimensionally unstable when exposed to water/organic solvent. Catalyst inks employ water/organic solvent to disperse the electrocatalyst and this can cause the membrane to swell, creating defects in the layer. Such issues may be mitigated on a small scale (e.g., laboratory scale) but prove more challenging in real-life situations.

Park et al. (Journal of Power Sources, 479, 2020, 228819, ISSN 0378-7753) describes roll-to-roll production of catalyst-coated membranes for low-temperature electrolysers. First an IrO₂ ink was roll-to-roll (R2R) direct coated onto a membrane (80 to 100 °C) and then a Pt/C electrocatalyst layer was applied by spray coating. There is no disclosure of subjecting the first catalyst layer to a temperature of 130 °C or more.

The method of the present invention allows both sides of the electrolyte membrane to be coated directly with catalyst ink. The second catalyst layer is applied to the electrolyte membrane after the first layer has been subjected to the temperature A. Without being bound by theory, the inventors submit that the use of the temperature A changes the structure of the first catalyst layer. This change of structure provides benefits for subsequent processing and the resulting CCM. The use of temperature A which is higher than temperature B offers improvements in cell performance of the resulting CCM.

The invention also resides in a CCM obtained or obtainable by the method of the invention, and its use in electrochemical devices such as fuel cells and electrolysers.

### DETAILED DESCRIPTION

The method of the invention requires the first catalyst layer to be subjected to a temperature A before deposition of the second catalyst ink. As such, the second catalyst ink is deposited onto second face of the electrolyte membrane, opposite to the first catalyst layer.

### Temperature A

The temperature A is 130 °C or more. The temperature A may be 135 °C or more, 140 °C or more, 145 °C or more, 150 °C or more, 155 °C or more, 160 °C or more or 165 °C or more; and/or the temperature A may be 220 °C or less, 210 °C or less, 200 °C or less, 190 °C or less, 180 °C or less or 170 °C or less.

In one embodiment the temperature A is from 135 to 175 °C, such as 140 to 170 °C, as demonstrated in the examples.

### Wet Catalyst Layer

The method comprises depositing a first catalyst ink onto the first face of the electrolyte membrane to form a first wet catalyst layer. The catalyst ink can be deposited as a single continuous strip on the electrolyte membrane along a length of the electrolyte membrane (i.e. in a machine direction), for example, so as to extend substantially fully along a length of the membrane. The catalyst ink can be deposited as a plurality of parallel continuous strips in the machine direction, each continuous strip suitably extending substantially fully along a length of the ion-conducting membrane. Alternatively, the catalyst formulation can be deposited as a plurality of spaced apart (i.e. discontinuous) patches, wherein each patch is spaced apart in the machine direction. Each continuous strip or patch can extend partially or fully across the width of the membrane (i.e. in a transverse direction). The wet catalyst layer can extend partially or fully across the width of the membrane (i.e. in the transverse direction).

The first catalyst ink may be deposited using a slot-die coating process, knife-coating, bar coating, inkjet printing, gravure printing, curtain coating, screen printing, or a spray coating process.

Preferably, the first catalyst ink is deposited by slot-die. The slot-die coating process allows the wet catalyst layer to be formed in a single pass and with a consistent thickness. In contrast, spray coating requires multiple coats to achieve the required thickness and there is more variability in thickness.

The first wet catalyst layer may be obtained by depositing a single layer. Alternatively the first wet catalyst layer may be obtained by depositing two or more sub-layers, i.e. by building up the wet layer before drying.

Preferably the first wet catalyst layer is obtained by depositing a single layer to reduce the number of steps required to make the CCM. Methods of the present invention can allow thicker catalyst layers to be deposited in a single pass, whilst maintaining acceptably low levels of cracking defects. The first wet catalyst layer may have a thickness of at least 50 μm, at least 70 μm, or at least 100 μm; and/or the first wet catalyst layer may have a thickness of 150 μm or less, 120 μm or less or 90 μm or less, e.g. from 50 to 90 μm. The wet layer thickness can be measured directly. However, it may be more practical to determine the wet layer thickness from the dry layer thickness and the solids content of the catalyst ink.

### Drying

A drying oven or furnace (e.g. heated by hot air impingement and/or infrared) may be employed to dry the first wet catalyst layer and/or to subject the first catalyst layer to the temperature A.

Preferably, the drying oven or furnace is in the form of a drying tunnel, i.e. having two separate openings (an entrance and an exit) to allow an object to be transported in one opening, through the tunnel and out again. This allows the process to be operated continuously, rather than as a batch process.

The wet catalyst layer can be dried quickly by conveying it through a drying tunnel, e.g. at a rate of at least 2 m/min (2 metres per minute), at least 5 m/min, or at least 10 m/min; and/or at a rate of 20 m/min or less or 15 m/min or less.

The first catalyst layer may be subjected to the temperature A by conveying it through a drying tunnel. A drying tunnel can be employed to ensure that substantially all of the dispersant from the catalyst ink is removed in a single heating step.

Preferably a single drying tunnel is employed to dry the first wet catalyst layer and subsequently to subject the first (dried) catalyst layer to the temperature A. In this way the first wet catalyst layer may be dried, and the first catalyst layer can be subjected to the temperature A by a single pass through the drying tunnel. The drying tunnel may comprise two or more zones having different temperatures. For example, one zone may have a temperature lower than the temperature A and another zone may have a temperature at or above A. In this way, one zone may be useful for drying the wet catalyst layer and another zone can be used to anneal the resulting dried catalyst layer. Preferably a single drying tunnel is employed to both dry the first wet catalyst layer and then subject the first (dried) catalyst layer to the temperature A where A is from 135 to 175 °C, as shown in the examples.

### Electrolyte Membrane

Providing the electrolyte membrane may comprise unwinding the electrolyte membrane from a supply roller. The electrolyte membrane may be provided as part of a laminated base material and providing the electrolyte membrane may comprise unwinding the laminated base material from the supply roller, the laminated base material comprising the electrolyte membrane and a first support film located on the second face of the electrolyte membrane.

The base material may be rewound onto a collection roller after the first catalyst layer has been applied. Hence the method may additionally comprise re-winding the electrolyte membrane onto a collection roller, the electrolyte membrane being disposed between the first catalyst layer and the first support film.

The electrolyte membrane comprises an ion-conducting polymer. The ion-conducting polymer is suitably a proton-conducting polymer. Preferred ion-conducting polymers are partially- or fully-fluorinated sulphonic acid polymers e.g. perfluorinated sulphonic acid polymers. For example, the ion-conducting polymer may be based on a perfluorinated sulphonic acid material such as Nafion® (Chemours Company), Aquivion® (Solvay Specialty Polymers), Flemion® (Asahi Glass Group) and Aciplex® (Asahi Kasei Chemicals Corp.). Alternatively, the ion-conducting materials may be based on a sulphonated hydrocarbon polymer, such as those available from FuMA-Tech GmbH as the Fumapem® P, E or K series of products, JSR Corporation, Toyobo Corporation, and others.

The electrolyte membrane can comprise a reinforcing component, such as a planar reinforcing component. Preferably, the reinforcing component is porous (i.e. comprises pores). The reinforcing component can confer mechanical strength to the ion-conducting membrane. The reinforcing component can contain a porous reinforcing material, such as an expanded polytetrafluoroethylene (ePTFE) material or a nanofibre network, such as a network comprising polybenzimidazole (PBI) fibres or glass fibres.

Typically in the methods of manufacturing the catalyst-coated membrane, the electrolyte membrane is an elongate strip.

The electrolyte membrane can optionally be provided on a support film such that the face on which the first catalyst ink is deposited is facing away from the support film. The support film provides support and dimensional stability during the step of forming the first catalyst layer and if not immediately removed, can provide support and strength during any subsequent storage and/or transport. The material from which the support film is made should provide the required support, be able to withstand the process conditions involved in producing the first catalyst layer be able to be easily removed without damage, to allow the second catalyst layer to be applied. Examples of materials suitable for use include a fluoropolymer, such as polytetrafluoroethylene (PTFE), ethylene tetrafluoroethylene (ETFE), perfluoroalkoxy polymer (PFA), fluorinated ethylene propylene (FEP—a copolymer of hexafluoropropylene and tetrafluoroethylene), and polyolefins, such as biaxially oriented polypropylene (BOPP).

### Second Wet Catalyst Layer

The second ink is deposited onto the second face of the electrolyte membrane to form the second catalyst layer. The second catalyst layer may be obtained by a roll-to-roll (R2R) process.

The electrolyte membrane may be supported on a roller during deposition. The roller may be a suction (vacuum) roller and/or a heated roller; and is preferably a heated suction roller. The electrolyte membrane has the first catalyst layer thereon and is fragile; the suction roller provides stability during deposition of the second catalyst ink. The heated roller dries the second catalyst ink.

In one embodiment depositing the second catalyst ink comprises a) unwinding an elongated porous base material from a porous base material supply roller toward the outer peripheral surface of a suction roller; b) sucking and supporting the porous base material on an outer surface of the suction roller; c) unwinding the electrolyte membrane from an electrolyte membrane supply roller toward a surface of the porous base material held on the outer peripheral surface of the suction roller; d) sucking and supporting the electrolyte membrane on an outer surface of the porous base material; e) applying the second catalyst ink onto the second face of the electrolyte membrane; f) separating the electrolyte membrane to which the second electrocatalyst layer ink is applied from the surface of the porous base material and winding the electrolyte membrane onto an electrolyte membrane collection roller; and g) separating said porous base material from the surface of the suction roller.

### Temperature B

The second catalyst layer is subjected to a temperature B and the temperature B is lower than the temperature A. In this way, the temperature A is the maximum temperature experienced by the first catalyst layer.

The temperature B may be lower than the temperature A by at least 40 °C, at least 50 °C, at least 60 °C, at least 70 °C, at least 80 °C or at least 90 °C. The temperature B may be 30 °C or more, 40 °C or more, or 50 °C or more; and/or the temperature B may be 100 °C or less, 90 °C or less, 80 °C or less, 70 °C or 60 °C or less. The second catalyst layer may be subjected to the temperature B by means of a heated roller (e.g. a heated suction roller).

### First and Second Catalyst Inks

The first catalyst ink and/or the second catalyst ink comprises an electrocatalyst, an ion-conducting polymer (e.g. PFSA) and a dispersant. Suitably, the dispersant comprises water and/or an organic solvent such as ethanol, propanol (n-propanol/iso-propanol), or a mixture thereof.

Suitably, the ion-conducting polymer is a proton-conducting polymer. Preferably, the ion-conducting polymer comprises sulfonic acid groups. The ion-conducting polymer is preferably a perfluorinated sulfonic acid (PFSA) ionomer, a partially-fluorinated sulfonic acid ionomer, a non-fluorinated hydrocarbon sulfonic acid ionomer, or mixtures thereof. It may be further preferred that the ion-conducting polymer is a perfluorinated sulfonic acid ionomer or a partially-fluorinated sulfonic acid ionomer. It may be particularly preferred that the ion-conducting polymer is a perfluorinated sulfonic acid ionomer. The catalyst inks may comprise a blend of ion-conducting polymers, such as a blend of perfluorinated sulfonic acid ionomers.

### First and Second Electrocatalysts

Typically the first electrocatalyst is different from the second electrocatalyst since they are employed to catalyse different reactions. Nonetheless each of the first electrocatalyst and the second electrocatalyst comprises metal particles optionally supported on an electrically conductive support. That is, each of the first and second electrocatalysts can be unsupported metal particles (e.g. finely divided unsupported metal powder) or may be a supported electrocatalyst wherein metal particles (e.g. nanoparticles) are dispersed on an electrically conductive support, such as an electrically conducting particulate carbon support. The metal particles of the electrocatalyst are suitably selected from:
(i) the platinum group metals (i.e. platinum, palladium, rhodium, ruthenium, iridium, and osmium),
(ii) gold or silver,
(iii) a base metal, or
(iv) an alloy or mixture comprising one or more of these metals or their oxides.

Preferably, the metal in the metal particles of the electrocatalyst is a platinum group metal or an alloy of a platinum group metal. The most preferred electrocatalyst metal is platinum, which may be alloyed with other precious metals or base metals. A base metal is tin or a transition metal which is not a noble metal. A noble metal is a platinum group metal (platinum, palladium, rhodium, ruthenium, iridium or osmium), silver or gold. Preferred base metals are copper, cobalt, nickel, zinc, iron, titanium, molybdenum, vanadium, manganese, niobium, tantalum, chromium and tin.

If the electrocatalyst is a supported catalyst, the loading of metal particles on the electrically conductive support material is suitably in the range 10 to 90 wt % or 20 to 80 wt %, such as 30 wt % to 75 wt %, preferably 40 wt % to 60 wt %, and most preferably 45 wt % to 55 wt % based on the weight of the electrocatalyst. The loading of the metal particles can be determined using inductively coupled plasma mass spectrometry (ICPMS).

Preferably, the electrocatalyst comprises an electrically conductive support and metal particles supported on the electrically conductive support. The term “supported” will be readily understood by a skilled person. For example, it will be understood that the term “supported” includes the metal particles of the electrocatalyst being dispersed on (and/or in the pores of) the support material and bound or fixed to the support material by physical or chemical bonds. For instance, the catalyst may be bound or fixed to the support material by way of ionic or covalent bonds, or non-specific interactions such as van der Waals forces.

The electrically conductive support may be an electrically conductive carbon support material. Suitably, the electrically conductive carbon support material is a carbon powder which may be, for example, a carbon black or graphitised carbon black for example a commercially available carbon black (such as from Cabot Corp. (Vulcan® XC72R) or Akzo Nobel (the Ketjen® black series)). Another suitable carbon support material is an acetylene black (e.g. those available from Chevron Phillips (Shawinigan Black®) or Denka). The electrically conductive carbon support can be prepared by the method disclosed in WO2013/045894. Alternatively, the electrically conductive support can be a metal oxide or a mixed oxide, in particular a conductive mixed oxide such as niobia-doped titania, phosphorus-doped tin oxide and mixed platinum group metal oxides or mixed metal oxides (as disclosed in WO2012/080726), a carbide (e.g. tungsten carbide, molybdenum carbide or titanium carbide, suitably tungsten carbide or titanium carbide), a nitride, in particular a conductive nitride (e.g. titanium nitride or titanium aluminium nitride).

Suitably, the first electrocatalyst comprises platinum (such as platinum on a carbon support) and the second electrocatalyst comprises platinum (such as platinum on a carbon support). It may be preferred, that the second catalyst ink additionally comprises an oxygen evolution catalyst, such as an iridium-containing catalyst (such as iridium oxide (IrOₓ), or an iridium metal oxide (for example an iridium ruthenium oxide or an iridium tantalum oxide). This combination of electrocatalysts may be useful when employing the CCM in a fuel cell.

Suitably, the first electrocatalyst comprises platinum (such as platinum on a carbon support) and the second electrocatalyst comprises iridium (such as iridium oxide (IrOₓ), or an iridium metal oxide (for example an iridium ruthenium oxide or an iridium tantalum oxide); or the first electrocatalyst comprises iridium (such as iridium oxide (IrOₓ), or an iridium metal oxide (for example an iridium ruthenium oxide or an iridium tantalum oxide) and the second electrocatalyst comprises platinum (such as platinum on a carbon support). This combination of electrocatalysts may be useful when employing the CCM in a water electrolyser.

### BRIEF DESCRIPTION OF THE DRAWINGS

Embodiments of the invention will now be described, by way of example only, with reference to the accompanying drawings, in which:

FIG. 1 is a flow diagram of an exemplary method of manufacturing a catalyst-coated membrane;

FIG. 2 is a schematic diagram of a CCM made according to an embodiment of the invention;

FIGS. 3 and 4 are schematic diagrams illustrating intermediates in the method of the invention.

FIG. 5 is a plot of a current density against temperature difference (temperature A-temperature B).

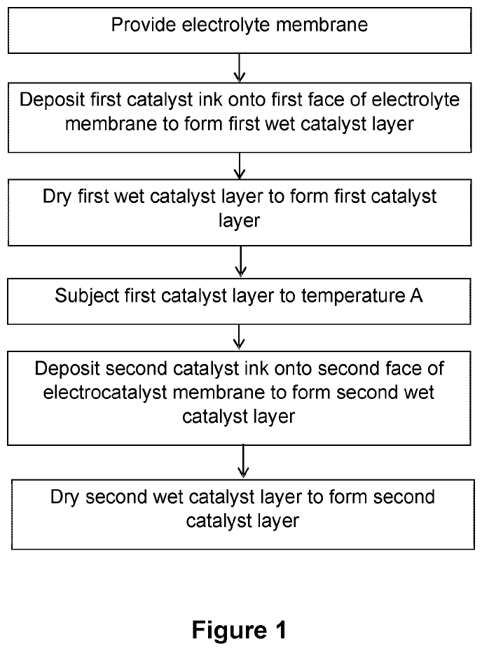

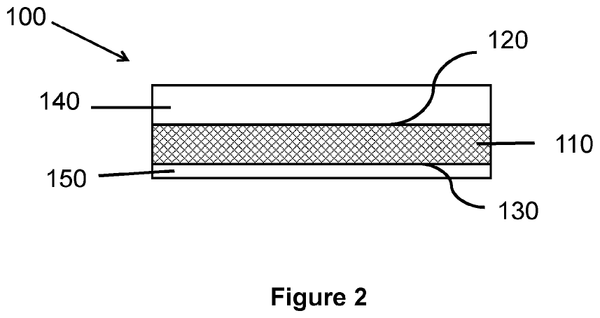

FIG. 1 shows a flow diagram of an exemplary method of manufacturing a CCM 100 shown in FIG. 2. Referring to FIG. 2 there is shown a schematic diagram of a cross-section of a catalyst-coated ion conducting membrane (CCM) 100 produced in accordance with an embodiment of the invention. The CCM 100 comprises an electrolyte membrane 110 having a first face 120 and an opposite second face 130. A first catalyst layer 140 is disposed on the first face 120 and a second catalyst layer 150 is disposed on the second face 130, so that the electrolyte membrane 110 is located between the first and second catalyst layers 140, 150.

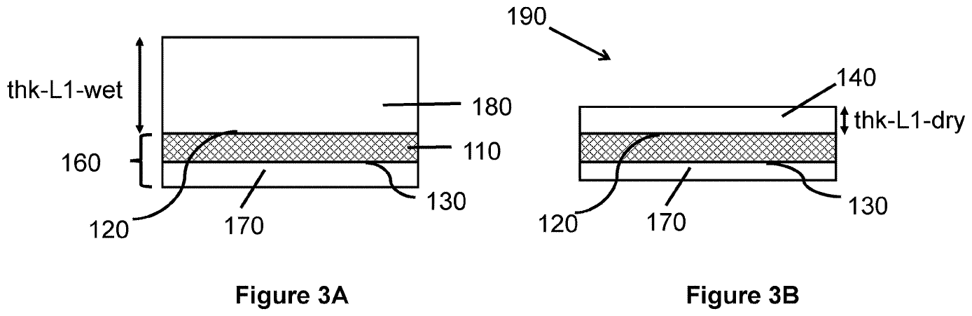

Referring to FIG. 3, the method comprises providing an electrolyte membrane 110, which has a first face 120 and a second face 130 on opposite sides of the electrolyte membrane. The electrolyte membrane may be elongate and unwound from a supply roller. Providing the electrolyte membrane 110 may comprise unwinding a laminated base material 160 from the supply roller, the base material 160 comprising the electrolyte membrane 110 and a first support film located 170 on the second face 130 of the electrolyte membrane.

A first catalyst ink is deposited directly onto the first face 120 of the electrolyte membrane 110, preferably by means of a slot die, to form a first wet catalyst layer 180, as shown in FIG. 3A. A slot die allows a wet catalyst layer 180 having a uniform thickness (thk-L1-wet) to be formed in a single pass. Spray coating would require multiple passes to achieve a similar thickness. The first wet catalyst layer thickness (thk-L1-wet) may be measured in a direction perpendicular to the first face 120 of the membrane.

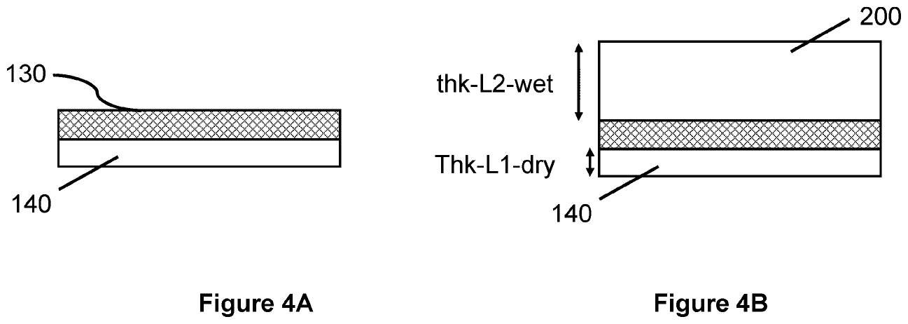

The first wet catalyst layer 180 is dried to form the catalyst layer 140 having a thickness (thk-L1-dry), as shown in FIG. 3B. It will be appreciated that the dry thickness is less than the wet thickness due to evaporation of the dispersant. FIG. 3B shows an intermediate 190 comprising an electrolyte membrane 110 having a first catalyst layer 140 on the first face 120 and a support film 170 on the opposite second face 130. The intermediate 190 may be distinguishable from those made according to conventional methods. In particular, the intermediate will not suffer from defects associated with hot pressing, as in the decal method. As such, there is a good interface between the membrane 110 and the first catalyst layer 140.

Where present, the support film 170 will need to be removed to allow a further catalyst layer to be applied to the second face 130. The electrolyte membrane may be inverted to allow the exposed second face 130 to face upwards, as shown in FIG. 4A. A second catalyst ink may be deposited directly onto the second face 130, preferably by means of a slot die, to form a second wet catalyst layer 200, as shown in FIG. 4B. The second wet catalyst layer 200 has a thickness (thk-L2-wet), measured in a direction perpendicular to the membrane. The second wet catalyst layer 200 can be dried to form the second catalyst layer 150, thereby forming the CCM 100 shown in FIG. 2.

### EXAMPLES

### Preparation of Cathode Catalyst Ink (First Catalyst Ink)

Cathode electrocatalysts were prepared using methods according to the general method for preparing carbon-supported platinum catalysts described in WO2013/045894.

A well-dispersed cathode catalyst ink was prepared by conventional means using an ionomer dispersion containing a perfluorinated sulphonic acid (PFSA) ionomer, the Pt/C electrocatalyst and a dispersant (a mixture of water and alcohol).

### Preparation of Anode Catalyst Inks (Second Catalyst Ink)

Anode electrocatalysts were prepared using methods according to the general method for preparing carbon-supported platinum catalysts described in WO2013/045894. A well-dispersed anode catalyst ink was prepared by conventional means using an ionomer dispersion containing a perfluorinated sulphonic acid (PFSA) ionomer, a Pt/C electrocatalyst, optionally an iridium containing OER catalyst, and a dispersant (water and alcohol mixture).

### First Catalyst Layer

The cathode catalyst ink was deposited onto a first face of an elongated electrolyte membrane using a slot die coating process to form a first wet catalyst layer. The coated electrolyte membrane was passed through a drying tunnel in a single pass; thereby drying the first wet catalyst layer and subjecting the first catalyst layer to a temperature A.

### Second Catalyst Layer

The anode catalyst ink was deposited onto a second face of the electrolyte membrane using a roll-to-roll process. The second catalyst ink is deposited by means of a slot-die onto a heated suction roller; thereby drying the second catalyst layer and subjecting the second catalyst layer to a temperature B (50 °C).

### Decal

For comparison, cathode catalyst layers were prepared using a decal transfer method as follows. The catalyst ink was deposited onto a decal transfer substrate (e.g. a skive PTFE sheet) using a slot die coating process and dried to remove the dispersant. The cathode catalyst layer was transferred to a first face of an electrolyte membrane using a decal process, in which heat and pressure were applied to transfer the cathode catalyst layer from the decal transfer substrate to the ion-conducting membrane to form a cathode catalyst layer.

An anode catalyst layer was prepared using a decal transfer method as follows. The anode catalyst ink was deposited onto a decal transfer substrate (e.g. a skive PTFE sheet) using a slot die coating process. The layer of anode ink was dried to remove the dispersant. The anode catalyst layer was transferred from the decal transfer substrate to a second face of an electrolyte membrane using a decal process. Heat and pressure were applied to transfer the anode catalyst layer from the decal transfer substrate to the ion-conducting membrane.

### Membrane Electrode Assembly (MEA) Preparation

Catalyst-coated membranes (CCMs) were prepared by first preparing a cathode catalyst layer on a first face of an ion-conducting membrane and subsequently preparing an anode catalyst layer on a second face of the (same) ion-conducting membrane using the methods described above.

A seal component was applied to a peripheral region of each face of the CCM. The seal component is non-ion-conducting.

A gas diffusion layer was applied to each face of the CCM to form a complete membrane electrode assembly. The gas diffusion layer used was a carbon fibre paper with a hydrophobic microporous layer containing carbon and PTFE applied to the face in contact with the catalyst-coated ion-conducting membrane.

### MEA Performance Testing

Temperature sweeps were performed by fixing the dew point of the hydrogen and air at the cell inlets to a temperature of 50 °C and controlling the cell temperature at different points between about 40 °C and 90 °C. The cell voltage (V) was measured at a current density of 1.2 A/cm².

| | Temperature | Temperature | Difference | Cell |
|---|---|---|---|---|
| | A | B | A − B (Δ | voltage at |
| | (°C) | (°C) | Temperature, °C) | 40 °C (V) |
| MEA1 | n/a | n/a | n/a | 0.54 |
| (Decal) | | | | |
| MEA2 | 80 | 50 | 30 | 0.15 |
| MEA3 | 140 | 50 | 90 | 0.35 |
| MEA4 | 160 | 50 | 110 | 0.57 |

For the DTM examples of the invention, drying the layer of cathode catalyst ink at a higher temperature improved the cell performance at relatively colder/wetter conditions (e.g. 40 °C). However, the performance was also maintained at relatively hotter/drier conditions. Overall, MEA4 (temperature A=160 °C, temperature B=50 °C) showed an improved cell performance at all temperature/relative humidity conditions tested when compared to MEA1 (i.e. comparative example prepared by a decal transfer process).

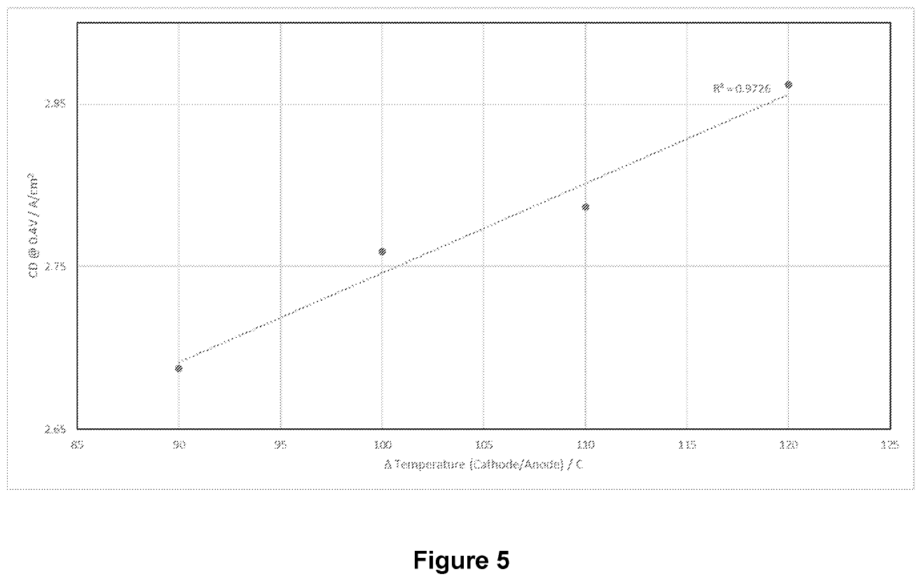

Further MEAs were prepared to investigate the effect of temperatures A and B on current density. As shown in FIG. 5, a good current density is obtained for MEAs produced according to the method of the invention. Moreover, increasing the difference between the temperature A (first catalyst layer) and temperature B (second catalyst layer) leads to an increase in current density.

1. A method of manufacturing a catalyst-coated membrane, the method comprising:
providing an electrolyte membrane having a first face and a second face, the first face being disposed opposite to the second face;
depositing a first catalyst ink onto the first face of the electrolyte membrane to form a first wet catalyst layer;
the first catalyst ink comprising a first ion-conducting polymer, a first electrocatalyst, and a first dispersant; and
drying the first wet catalyst layer to form a first catalyst layer on the first surface of the electrolyte membrane; and
depositing a second catalyst ink onto the second face of the electrolyte membrane to form a second wet catalyst layer, the second catalyst ink comprising a second ion-conducting polymer, a second electrocatalyst, and a second dispersant; and
drying the second wet catalyst layer to form a second catalyst layer;
wherein the first catalyst layer is subjected to a temperature A before the second catalyst ink is deposited onto the second face of the electrolyte membrane and the temperature A is 130 °C or more; and
wherein the second catalyst layer is subjected to a temperature B and the second temperature B is lower than the temperature A.

2. The method of claim 1, wherein the temperature B is at least 40 °C lower than the temperature A, preferably at least 50 °C, at least 60 °C, at least 70 °C, at least 80 °C or at least 90 °C lower than the temperature A.

3. The method of claim 1, wherein (i) the temperature A is from 130 to 220 °C; and/or (ii) the temperature B is from 30 to 100 °C.

4. The method of claim 1, wherein the temperature A is from 135 to 175 °C.

5. The method of claim 1, wherein subjecting the first catalyst layer to the temperature A comprises conveying through a drying tunnel.

6. The method of claim 5 wherein a single pass through the drying tunnel is employed to both dry the first wet catalyst layer to form the first catalyst layer and to subject the first catalyst layer to the temperature A.

7. The method of claim 1, wherein providing the electrolyte membrane comprises unwinding the electrolyte membrane from a supply roller.

8. The method of claim 7, wherein providing the electrolyte membrane comprises unwinding a laminated base material from the supply roller, the laminated base material comprising the electrolyte membrane and a first support film located on the second face of the electrolyte membrane.

9. The method of claim 8, additionally comprising re-winding the electrolyte membrane onto a collection roller, the electrolyte membrane being disposed between the first catalyst layer and the first support film.

10. The method of claim 1, wherein the first ink is deposited onto the first face of the electrolyte membrane by a roll-to-roll process.

11. The method of claim 1, wherein the first ink is deposited onto the first face of the electrolyte membrane by slot-die deposition.

12. The method of claim 1, wherein the first wet catalyst layer is obtained by depositing a single layer.

13. The method of claim 1, wherein the first wet catalyst layer is obtained by depositing two or more sub-layers.

14. The method of claim 13, wherein the first wet catalyst layer is obtained by spray coating.

15. The method of claim 1, wherein the second catalyst ink is deposited onto the second face of the electrolyte membrane by slot-die.

16. The method of claim 1, wherein the second catalyst ink is deposited onto the second face of the electrolyte membrane by a roll-to-roll process.

17. The method of claim 16, wherein the electrolyte membrane is supported on a heated roller during deposition of the second catalyst ink.

18. The method of claim 1, wherein the electrolyte membrane is supported on a suction roller during deposition of the second catalyst ink.

19. The method of claim 17, wherein the electrolyte membrane is supported on a heated suction roller during deposition of the second ink.

20. The method of claim 1 wherein
(i) the first electrocatalyst comprises a platinum electrocatalyst, such as a carbon supported platinum electrocatalyst; and/or
(ii) the first ion-conducting polymer comprises a perfluorinated sulfonic acid (PFSA) ionomer; and/or
(iii) the second electrocatalyst comprises a platinum electrocatalyst, such as a carbon supported platinum electrocatalyst; and/or
(iv) the second ion-conducting polymer comprises a perfluorinated sulfonic acid (PFSA) ionomer.

21. The method of claim 1 wherein (i) the first catalyst layer comprises a platinum electrocatalyst, such as a carbon supported platinum electrocatalyst; and (ii) the second catalyst layer comprises a platinum electrocatalyst, such as a carbon supported platinum electrocatalyst, and an oxygen evolution catalyst, such as an iridium-containing catalyst, such as iridium oxide (IrOₓ), or an iridium metal oxide.

22-24. (canceled)
